(19) United States
(12) Patent Application Publication
(10) Pub. No.: US 2008/0130283 A1
(43) Pub. Date: Jun. 5, 2008

(54) Lamp and lamp string

(76) Inventor: Che-Min Chang, Hsinchu Hsien (TW)

Correspondence Address: CHARLES E. BAXLEY, ESQ., 90 JOHN STREET, THIRD FLOOR, NEW YORK, NY, 10038, US

(21) Appl. No.: 11/096,570

(22) Filed: Apr. 1, 2005

(30) Foreign Application Priority Data
Apr. 2, 2004 (CN) CN 200420044305.4

(51) Int. Cl. F21S 4/00; H05B 37/00; F21V 27/00; F21V 21/00

(52) U.S. Cl. 362/249; 315/185 S; 362/391

(57) ABSTRACT

The invention discloses an LED lamp and an LED lamp string having a load connected to both ends of an LED, and the lamp acts like a non-polarized lamp to an alternate current and maintains to be half-wave lit. No consideration of anode and cathode is needed for connecting the LEDs of the lamp string in series on an electric wire. Even when an LED is damaged to produce an open circuit, electric current still can pass through the load connected to the damaged LED to light up the rest LEDs. Since the LED will not be damaged easily while blinking, the LED has a long life. It is not necessary to consider the polarity of the LED for its installation, and thus making the installation and replacement more convenient. The invention comes with a voltage divider or choke that can resist voltage or current surges.

### BACKGROUND OF THE INVENTION

1. Field of the Invention

The present invention generally relates to an illumination technology, and more particularly to a lamp and a lamp string.

2. Description of the Related Art

An incandescent lamp has a very limited brightness and a low applied voltage of generally several volts of an alternate current. The structure of incandescent lamps includes a tungsten filament inside a glass bulb. Incandescent lamps consume more electric power than other lamps, and the tungsten filament will be melted by heat easily, particularly when the voltage is turned on/off or when the lamp is blinking constantly. If lamps are connected to produce a lamp string, and any one or more lamps of the lamp string is busted, then the circuit of such lamp string will produce a temperature rise, the light bulb will become brighter, and the electric wire will produce lots of heat which has a high risk of causing a fire accident. Since a light emitting diode (LED) has the low drive voltage, power-saving, and uneasy-to-break features, the lamp using an LED as a light source has advantages of good vibration resistance, low power consumption, low heat generation and environmental protection. At present, the LED lamp is taking over the position of the incandescent lamp. An LED is unidirectional, and thus if a positive half cycle of an alternate current is applied to the anode and cathode of an LED, the LED is electrically connected to emit lights. If a negative half cycle is applied to the anode and cathode of an LED, the LED is electrically disconnected to turn off the light. The LED is maintained at half-wave lit within a cycle of voltage of an AC power. The general AC power has a frequency of 50 Hz˜60 Hz, and thus the LED is put off for only 0.01 sec, which is undetectable by human eyes, and thus the LED is seemingly lit all the time. However, the unidirectional conductivity of the LED requires the lamps of the lamp string to be connected in series along an electric wire before the LED lamps of the whole lamp string emit lights. If any lamp is connected in a wrong direction or damaged, then the whole lamp string will not be lit. Since the electric wire of the lamp string may be tangled, therefore the lamps are connected to a plurality of electric wires with their distal ends connected with each other for its manufacture or maintenance. Since the electric wires may be tangled at the adjacent ends of the electric wires, it is difficult to distinguish which one is a beginning end or an ending end in order to connect the LEDs properly on the electric wires. Users have to separate the tangled electric wires first before finding the proper ends for a correct connection. Such arrangement not only affects the structure of the electric wire, but also increases the user's workload and makes the operation inconvenient.

### SUMMARY OF THE INVENTION

It is a primary objective of the present invention to provide a long-life LED lamp, that requires no consideration of the direction of a power supply for connecting the LED lamp with an alternate current, and there is always a current passing through the lamp, regardless of the positive half cycle or negative half cycle of the power supply.

Another objective of the present invention is to provide a long-life, easy-to-install and easy-to-maintain lamp string that requires no consideration of a consistent direction of each lamp for connecting the lamp string with an alternate current, and there is always a current passing through the lamp, regardless of the positive half cycle or negative half cycle of the power supply.

The technical solution of the present invention resides on that the lamp comprises a light emitting diode (LED) and a load connected separately to both ends of the LED. The load could be a rectification diode, a regulated diode or a Zener diode connected in parallel with the foregoing LED in an opposite direction. The load could be two regulated diodes or two-way regulated diodes connected in series in opposite directions. The load could be a surge protection diode. The load could be connected in parallel with two pins in the package casing of the LED. The load could be connected to two chips of the LED. The load could be connected in parallel with two external conductive wires outside the package casing of the LED.

The lamp string comprises a light emitting diode (LED) and a main electric wire; wherein the main electric wire has separate branch electric wires, and each branch electric wire comes with a lamp holder. The foregoing load is connected in parallel with two pins in the package casing of the foregoing LED, and the lamp holder has two conductors separately connected to two disconnected points of the branch electric wire, and two external conductive wires of the LED are inserted into the two conductors in the lamp holder correspondingly.

The lamp of the present invention comprises a load connected in parallel with both ends of an LED, such that if an alternate current (AC) voltage is applied to both ends of the LED and the positive half cycle of the alternate current is applied to the anode and cathode of the LED, the LED is electrically connected to emit lights.

If a negative half cycle of voltage of the alternate current is applied to the anode and cathode of a light emitting diode, the light emitting diode stops emitting lights, and by then both ends of the load bear a very high voltage, and thus the current of the circuit will punch and pass through the load. The lamp employing this kind of light emitting diodes according to the invention acts as a non-polarized lamp with respect to the alternate current power, and a cycle of voltage of the alternate current is maintained half-wave lit all the time. In general, the frequency of an alternate current is 50 HZ□60 HZ, and thus the time for the light emitting diode to be turned off is about 0.01 second each time and such light emitting diode is seemingly lit all the time to our eyes. The lamp string employing this kind of lamps connects the light emitting diode lamps in series on an electric wire, without the need of taking the polarity into consideration. Even if any of the light emitting diodes is damaged and an open circuit is resulted, an electric current still can pass through the lamp because the lamp is connected with in parallel a load. As a result, other light emitting diodes connected on the same electric wire still are electrically connected to emit lights. Since a light emitting diode will not break down easily when it is blinking, therefore the light emitting diode has a long life. Further, it is not necessary to take the polarity of the light emitting diode into consideration for the installation, and thus making the installation and replacement more convenient. With a voltage divider and a choke, an excessively large voltage will not be added forcefully to the connected light emitting diodes, even if several light emitting diodes have lost their light emitting function. A damaged light emitting diode will not cause a failure of the whole circuit. The invention can stand a surge voltage or current, and thus can protect the light emitting diode from being deteriorated, damaged or failed when plugging or unplugging the light emitting diode.

### BRIEF DESCRIPTION OF THE DRAWINGS

FIG. 1 is a circuit diagram of a lamp according to the present invention;

FIG. 2 is a circuit diagram of a load being a rectification diode according to the present invention;

FIG. 3 is a circuit diagram of a load being a regulated diode according to the present invention;

FIG. 4 is a circuit diagram of a load being a Zener diode according to the present invention;

FIG. 5 is a circuit diagram of a load being a two-way regulated diode according to the present invention;

FIG. 6 is a circuit diagram of a load being a surge protection diode according to the present invention;

FIG. 7 is a schematic view of another lamp according to the present invention;

FIG. 8 is a schematic view of a further lamp according to the present invention;

FIG. 9 is a schematic view of a lamp string according to the present invention;

FIG. 10 is a schematic view of another lamp string according to the present invention;

FIG. 11 is a circuit diagram of a load being a two-way regulated tube as depicted in FIGS. 9 and 10;

FIG. 12 is a circuit diagram of a load being a surge protection diode as depicted in FIGS. 9 and 10;

FIG. 13 is a circuit diagram of a load being a rectification diode as depicted in FIG. 9; and

FIG. 14 is a circuit diagram of a load being a regulated diode or a Zener diode as depicted in FIG. 9.

### DETAILED DESCRIPTION OF THE PREFERRED EMBODIMENTS

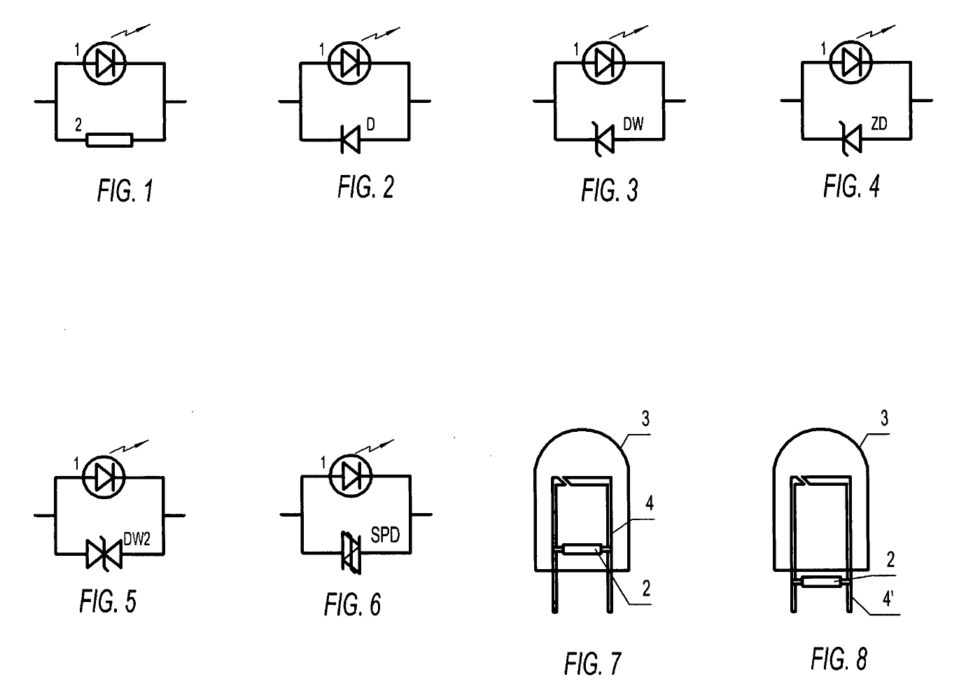

Referring to FIG. 1 for the circuit of a lamp in accordance with the present invention, and the lamp could be an illuminating lamp, a searchlight, or a decorative Christmas lamp. The lamp of this embodiment is a decorative lamp, which includes a light emitting diode 1 and a load 2 separately connected to both ends of the light emitting diode 1.

Referring to FIG. 2, the load 2 is a rectification diode D connected in parallel with the light emitting diode 1 in an opposite direction. If the decorative lamp is connected with an alternate current and a positive half cycle of an alternate current is applied to the anode and cathode of the light emitting diode 1, the light emitting diode 1 is electrically connected to emit lights. By then, the rectification diode D is disconnected. If a negative half cycle of an alternate current is applied to the anode and cathode of the light emitting diode 1, the light emitting diode 1 is electrically disconnected and turned off, and the rectification diode D is electrically connected. Therefore, an electric current still can pass through the decorative lamp and maintain a half cycle of the added voltage on the decorative lamp all the time so as to electrically connect the light emitting diode 1 to emit lights. Further, another half cycle passes through the rectification diode D for an electric connection, and thus in a cycle of an alternate current, an electric current can pass through the decorative lamp made of the light emitting diode 1 and the rectification diode D all the time.

Referring to FIG. 3, the load 2 is a regulated diode DW connected in parallel with the light emitting diode 1 in an opposite direction. If the decorative lamp is connected to an alternate current and a positive half cycle of the alternate current is applied to the anode and cathode of the light emitting diode 1, the regulated diode DW is disconnected. If a negative half cycle of the alternate current is applied to the anode and cathode of the light emitting diode 1, the light emitting diode 1 is disconnected and turned off, and the regulated diode DW is electrically connected. Therefore, an electric current still can pass through the decorative lamp and maintain a half cycle of the added voltage on the decorative lamp all the time so as to electrically connect the light emitting diode 1 to emit lights. Further, another half cycle passes through the regulated diode DW for an electric connection, and thus in a cycle of an alternate current, an electric current can pass through the decorative lamp made of the light emitting diode 1 and the regulated diode DW all the time.

Referring to FIG. 4, the load 2 is a Zener diode ZD connected in parallel with the light emitting diode 1 in an opposite direction. If the decorative lamp is connected with an alternate current and a positive half cycle of an alternate current is applied to the anode and cathode of the light emitting diode 1, the Zener diode ZD is electrically disconnected. If a negative half cycle of an alternate current is applied to the anode and cathode of the light emitting diode 1, the light emitting diode 1 is electrically disconnected and turned off, and the Zener diode ZD is electrically connected. Therefore, an electric current still can pass through the decorative lamp and maintain a half cycle of the added voltage on the decorative lamp all the time so as to electrically connect the light emitting diode 1 to emit lights. Further, another half cycle passes through the Zener diode ZD for an electric connection, and thus in a cycle of an alternate current, an electric current can pass through the decorative lamp made of the light emitting diode 1 and the Zener diode ZD all the time.

Referring to FIG. 5, the load 2 is a two-way regulated tube DW2 connected in parallel with both ends of the light emitting diode 1 in an opposite direction. If the decorative lamp is connected with an alternate current and a positive half cycle of an alternate current is applied to the anode and cathode of the light emitting diode 1, the light emitting diode 1 is electrically connected to emit lights. If a negative half cycle of an alternate current is applied to the anode and cathode of the light emitting diode 1, the light emitting diode 1 is electrically disconnected and turned off, and the two-way regulated tube DW2 is punched and the electric current passes through the two-way regulated tube DW2. Therefore, a half cycle of the added voltage on the decorative lamp is maintained all the time so as to electrically connect the light emitting diode 1 to emit lights. Further, another half cycle passes through the two-way regulated tube DW2 for an electric connection, and thus in a cycle of an alternate current, an electric current can pass through the decorative lamp made of the light emitting diode 1 and the two-way regulated tube DW2 all the time.

Referring to FIG. 6, the load 2 is a surge protection diode SPD connected in parallel with both ends of the light emitting diode 1 in an opposite direction. If the decorative lamp is connected with an alternate current and a positive half cycle of an alternate current is applied to the anode and cathode of the light emitting diode 1, the light emitting diode 1 is electrically connected to emit lights. If a negative half cycle of an alternate current is applied to the anode and cathode of the light emitting diode 1, the light emitting diode 1 is electrically disconnected and turned off, and the surge protection diode SPD is electrically connected. An electric current still can pass through the decorative lamp. Therefore, a half cycle of the added voltage on the decorative lamp is maintained all the time so as to electrically connect the light emitting diode 1 to emit lights. Further, another half cycle passes through the surge protection diode SPD for an electric connection, and thus in a cycle of an alternate current, an electric current can pass through the decorative lamp made of the light emitting diode 1 and the surge protection diode SPD all the time.

Referring to FIG. 7 for a structure of a lamp in accordance with the present invention, the structure comprises a load 2 and two pins disposed in a package casing 3 and connected in parallel with a light emitting diode 1.

Referring to FIG. 8 for another structure of a lamp in accordance with the present invention, the load 2 is connected to two external conductive wires 4′ in parallel with a light emitting diode 1.

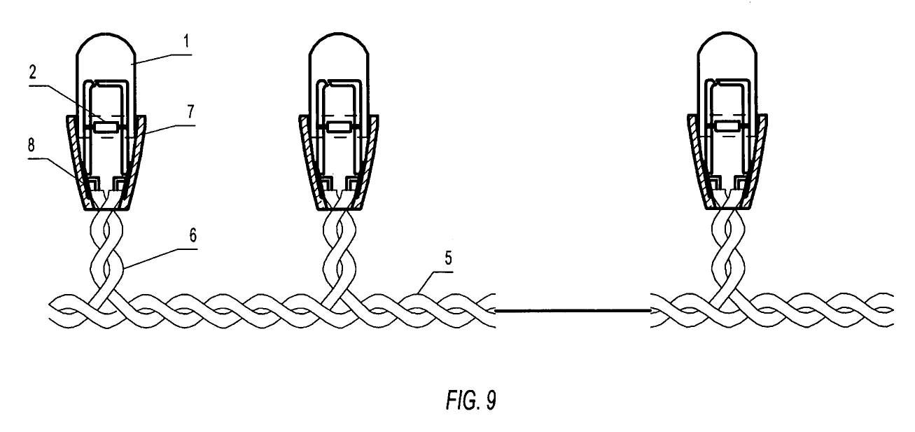

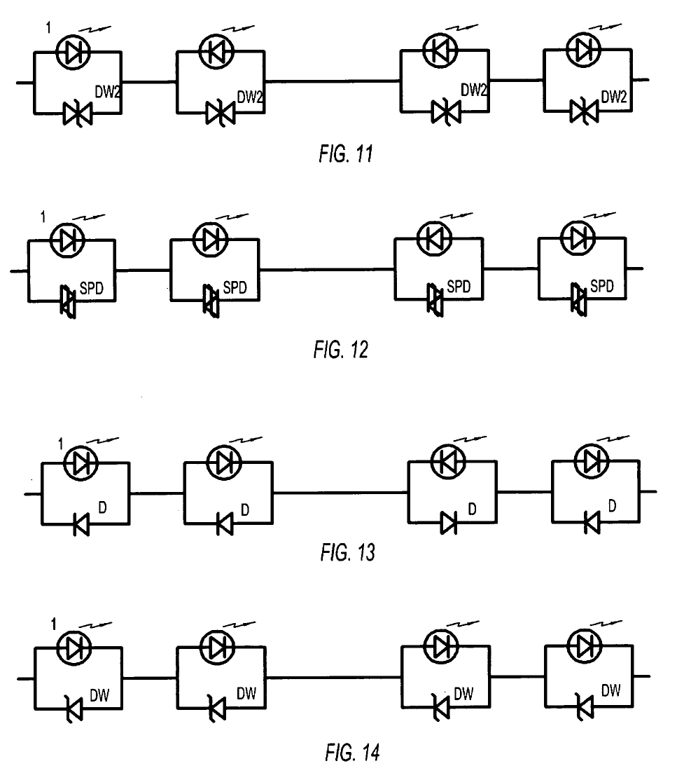

Referring to FIG. 9 for a decorative lamp used as a preferred embodiment of the present invention, the structure comprises a light emitting diode 1, a load 2, a main electric wire 5, a branch electric wire 6, a lamp holder 7 and a conductive plate 8. The decorative lamps are connected in series with an alternate current with a voltage of 120V. The decorative lamp string includes 60 lamp holders 7. The main electric wire 5 is connected to a ground wire and a fire wire, and the ground wire is extended to 60 branch electric wires 6. The branch electric wire 6 has a disconnected opening thereon, and each branch electric wire 6 is connected to a lamp holder 7. The lamp holder 7 has two conductive plates 8 electrically connected to the disconnected points of the branch electric wire 6. The two pins 4 in the package casing 3 of the light emitting diode 1 is connected with a load 2, and the two external conductive wires 4′ of the light emitting diode 1 are inserted into the two conductive plates 8 in the lamp holder 7. The circuit of the decorative lamp string with this kind of structure is illustrated in FIGS. 11 to 14. The load 2 is a rectification diode D, a regulated diode DW or a Zener diode ZD connected in parallel with both ends of the light emitting diode 1 in an opposite direction, or the load 2 is a two-way regulated diode DW2 or a surge protection diode SPD connected in parallel with both ends of the light emitting diode 1. Since the load 2 is installed in the package casing 3 of the light emitting diode 1 and each decorated lamp made of the light emitting diode 1 and the load 2 acts as a non-polarized lamp with respect to an alternate current, therefore the current can pass through the decorative lamp regardless of the consistency of the serially connected light emitting diode 1. There is no need to take the polarity into consideration for the assembly during the manufacture of the decorative lamp, greatly improving the working efficiency and lower the labor costs. For maintenance, users can replace any damaged light emitting diode 1 on their own by simply unplugging the bad light emitting diode 1 and inserting a new light emitting diode 1. Since the light emitting diode 1 has a preinstalled load 2, the newly inserted light emitting diode 1 does not have a surge voltage on both ends of the light emitting diode 1, and the light emitting diode 1 will not be burned easily. Since the prior art connects the all light emitting diodes 1 in series, the light emitting diodes 1 will be burned or damaged easily, if there is a bad light emitting diode 1 in the decorative lamp string and such bad light emitting diode 1 is unplugged, because the voltage at both ends of the open circuit is 120 or 220V and the newly added light emitting diode 1 will be surged and damaged, which will reduce the life of use. On the other hand, the present invention includes a load 2 connected in series with a power of 120V or 220V, and thus having a good protection and preventing the light emitting diode 1 from being surged or burned, so as to extend the life of the light emitting diode 1.

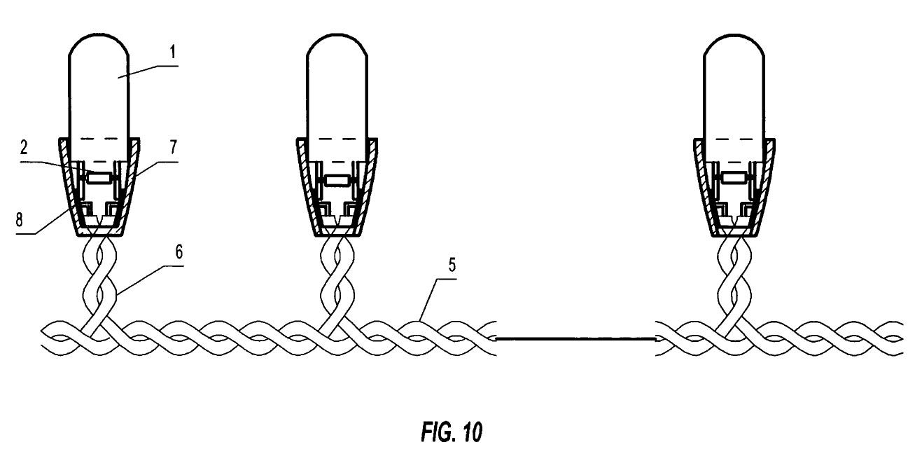

Another structure of the decorative lamp string in accordance with the invention is illustrated in FIG. 10. The structure comprises a light emitting diode 1, a load 2, a main electric wire 5, a branch electric wire 6, a lamp holder 7 and a conductive plate 8. The main electric wire 5 has a ground wire and a fire wire. The ground wire 5 is extended to a plurality of the branch electric wire 6 according to the quantity of the lamps in the decorative lamp string. The branch electric wire 6 has disconnected opening, and each branch electric wire 6 is connected to a lamp holder 7. The lamp holder 7 includes two conductive plate 8 electrically connected to two disconnected points of the branch electric wire 6. The load 2 is connected to the two conductive plates 8, and the two external conductive wires 4′ of the light emitting diode 1 are inserted separately and correspondingly into the two conductive plates 8 of the lamp holder 7. The circuit of the decorative lamp string with this structure is illustrated in FIGS. 11 and 12. The load 2 is a two-way regulated diode DW2 or a surge protection diode SPD disposed on both ends of the light emitting diode 1, and thus each decorative lamp comprised of a light emitting diode 1 and a two-way regulated diode DW2 or a surge protection diode SPD with respect to an alternate current is not affected by the polarity of the light emitting diode 1, and acts like a non-polarized lamp. Regardless of the consistency of the serially connected light emitting diode 1, an electric current can pass through the decorative lamp. Similarly, it is not necessary to take the polarity into consideration for the installation, and thus improving the working efficiency and lowering the labor cost. For replacing the light emitting diode 1, the light emitting diode 1 will not be surged or damaged by the surge produced on both ends of the newly inserted light emitting diode 1, since the entire circuit has installed the two-way regulated tube DW2 or a surge protection diode SPD in advance. Therefore, the present invention can extend the life of the light emitting diode 1.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lamp, comprising:
a light emitting diode, characterized in that a load is connected separately with both ends of said light emitting diode in parallel.

2. The lamp of claim 1, wherein said load is a rectification diode connected in an opposite direction with said light emitting diode in parallel.

3. The lamp of claim 1, wherein said load is a regulated light emitting diode connected in an opposite direction with said light emitting diode in parallel.

4. The lamp of claim 1, wherein said load is a Zener light emitting diode connected in parallel with said light emitting diode in an opposite direction.

5. The lamp of claim 1, wherein said load refers to two regulated light emitting diodes or two-way regulated light emitting diodes connected in series in an opposite direction.

6. The lamp of claim 1, wherein said load is surge suppression light emitting diode.

7. The lamp as cited in any of claims 1, wherein said load is connected in parallel with two pins disposed in a package casing of said light emitting diode.

8. The lamp as cited in any of claims 2, wherein said load is connected in parallel with two pins disposed in a package casing of said light emitting diode.

9. The lamp as cited in any of claims 3, wherein said load is connected in parallel with two pins disposed in a package casing of said light emitting diode.

10. The lamp as cited in any of claims 4, wherein said load is connected in parallel with two pins disposed in a package casing of said light emitting diode.

11. The lamp as cited in any of claims 5, wherein said load is connected in parallel with two pins disposed in a package casing of said light emitting diode.

12. The lamp as cited in any of claims 6, wherein said load is connected in parallel with two pins disposed in a package casing of said light emitting diode.

13. The lamp as cited in any of claims 1, wherein said load is connected in parallel with two chips of said light emitting diode.

14. The lamp as cited in any of claims 2, wherein said load is connected in parallel with two chips of said light emitting diode.

15. The lamp as cited in any of claims 3, wherein said load is connected in parallel with two chips of said light emitting diode.

16. The lamp as cited in any of claims 4, wherein said load is connected in parallel with two chips of said light emitting diode.

17. The lamp as cited in any of claims 5, wherein said load is connected in parallel with two chips of said light emitting diode.

18. The lamp as cited in any of claims 6, wherein said load is connected in parallel with two chips of said light emitting diode.

19. The lamp as cited in any of claims 1, wherein said load is connected in parallel with two external conductive wires of a package casing of said light emitting diode.

20. The lamp as cited in any of claims 2, wherein said load is connected in parallel with two external conductive wires of a package casing of said light emitting diode.

21. The lamp as cited in any of claims 3, wherein said load is connected in parallel with two external conductive wires of a package casing of said light emitting diode.

22. The lamp as cited in any of claims 4, wherein said load is connected in parallel with two external conductive wires of a package casing of said light emitting diode.

23. The lamp as cited in any of claims 5, wherein said load is connected in parallel with two external conductive wires of a package casing of said light emitting diode.

24. The lamp as cited in any of claims 6, wherein said load is connected in parallel with two external conductive wires of a package casing of said light emitting diode.

25. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 1, and said lamp holder includes two conductors electrically and separately connected to two disconnected points of said branch electric wires, and said two external electric conductive wires are inserted separately and correspondingly into said two conductors in said lamp holder.

26. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 2, and said lamp holder includes two conductors electrically and separately connected to two disconnected points of said branch electric wires, and said two external electric conductive wires are inserted separately and correspondingly into said two conductors in said lamp holder.

27. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 3, and said lamp holder includes two conductors electrically and separately connected to two disconnected points of said branch electric wires, and said two external electric conductive wires are inserted separately and correspondingly into said two conductors in said lamp holder.

28. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 4, and said lamp holder includes two conductors electrically and separately connected to two disconnected points of said branch electric wires, and said two external electric conductive wires are inserted separately and correspondingly into said two conductors in said lamp holder.

29. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 5, and said lamp holder includes two conductors electrically and separately connected to two disconnected points of said branch electric wires, and said two external electric conductive wires are inserted separately and correspondingly into said two conductors in said lamp holder.

30. A lamp string, comprising a light emitting diode and a main electric wire, and said main electric wire having a plurality of disconnected branch electric wires and said each branch electric wire having a lamp holder disposed thereon, characterized in that said two pins disposed in said package casing of said light emitting diode are connected to any load as cited in any one of claims 6, and said lamp holder includes two conductors electrically and separately connected to two disconnected points of said branch electric wires, and said two external electric conductive wires are inserted separately and correspondingly into said two conductors in said lamp holder.

31. A lamp string, comprising a light emitting diode and a main electric wire, and said main electric wire having a plurality of disconnected branch electric wires and said each branch electric wire having a lamp holder disposed thereon, characterized in that said lamp holder includes two conductors electrically and separately connected to two disconnected points of said branch electric wires, and said load as cited in claims 5 is installed in said lamp holder, and both ends of said load are electrically and separately connected to two disconnected points of said branch electric wires, and said two external electric conductive wires are inserted separately and correspondingly into said two conductors in said lamp holder.

32. A lamp string, comprising a light emitting diode and a main electric wire, and said main electric wire having a plurality of disconnected branch electric wires and said each branch electric wire having a lamp holder disposed thereon, characterized in that said lamp holder includes two conductors electrically and separately connected to two disconnected points of said branch electric wires, and said load as cited in claims 6 is installed in said lamp holder, and both ends of said load are electrically and separately connected to two disconnected points of said branch electric wires, and said two external electric conductive wires are inserted separately and correspondingly into said two conductors in said lamp holder.
